(19) United States
(12) Patent Application Publication
(10) Pub. No.: US 2010/0294673 A1
(43) Pub. Date: Nov. 25, 2010

(54) POROUS MONOLITHIC MATERIALS

(75) Inventors: Matthias Koch, Wiesbaden (DE); Joerg Pahnke, Darmstadt (DE); Gerhard Jonschker, Heppenheim (DE); Stefan Spange, Orlamuende (DE); Patrick Kempe, Chemnitz (DE); Silke Grund, Chemnitz (DE); Elias Klemm, Nuernberg (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GESELLSCHAFT MIT BESCHRANKTER HAFTUNG, DARMSTADT (DE)

(21) Appl. No.: 12/810,798

(22) PCT Filed: Dec. 1, 2008
(86) PCT No.: PCT/EP08/10168

§ 371 Date: Aug. 16, 2010

(30) Foreign Application Priority Data
Dec. 27, 2007 (DE) 10 2007 063 297.7

(51) Int. Cl. F17C 11/00; B01J 20/22; B01J 20/26

(52) U.S. Cl. 206/7; 502/401; 502/402

(57) ABSTRACT

The invention relates to monolithic materials which consist of porous, preferably highly porous, carbon and are suitable, inter alia, for the storage of gases, such as, for example, hydrogen and methane, and for absorptive and adsorptive gas purification.

The invention relates to monolithic materials which consist of porous, pref-erably highly porous, carbon and are suitable, inter alia, for the storage of gases, such as, for example, hydrogen and methane, absorptive and adsorptive gas purification.

The term “monolith” means that the majority of the material is in the form of a coherent piece whose dimensions are greater than those of conventional granules.

The storage of gases, in particular hydrogen, has increasing economic importance. Materials which are able to adsorb the gases on a large surface allow the construction of gas tanks without high-pressure or cryotechnology. This is intended to form the basis for conversion of vehicles powered today using liquid fuel to environmentally friendly or even environmentally neutral gaseous fuels. The gaseous fuels with the greatest existing and future economic and political potential have been identified as natural gas/methane and hydrogen.

The prior art in the case of gas-powered vehicles today is pressurised storage in steel bottles and to a small extent in composite bottles. In CNG (compressed natural gas) vehicles, natural gas is stored at a pressure of 200 bar. In most prototypes of hydrogen-powered vehicles, pressurised storage systems with 350 bar or to a small extent cryogenic liquid hydrogen systems at −253° C. (20 K) are used.

A future solution which is already being developed is pressure systems for 700 bar, which have a volume-based storage density comparable to liquid hydrogen. Common features of these systems are still a low volume efficiency and a high weight, which limits the range of the vehicles to about 350 km (CNG vehicles) or 250 km (hydrogen vehicles). Furthermore, the high energy expenditure for compression and in particular for liquefaction represents a further disadvantage which reduces the possible ecological advantages of gas-powered vehicles. In addition, the tank design must take into account storage at very low temperatures (20 K) by means of extreme insulation. Since complete insulation cannot be achieved, a considerable leakage rate in the order of 1-2% per day must be expected for such tanks. Given the above-mentioned energetic and economic (infrastructure costs) aspects, pressurised storage is regarded as being the most promising technique for gaseous fuels natural gas (CNG) and later hydrogen for the foreseeable future.

An increase in the pressure level to above 200 bar in the case of CNG would be difficult to imagine from a technical and economic point of view, since an extensive infrastructure and rapidly growing vehicle stock of currently about 50,000 cars already exist in Germany. Thus, potential solutions for increasing the storage capacity remain optimisation of the tank geometry (avoidance of individual cylinders, structure tank in “cushion form”) and an additional, supporting storage principle, such as adsorption.

This potential solution could also be applied to hydrogen, where even greater advantages would be expected than in the case of natural gas. The reason for this is the real gas behaviour of hydrogen (real gas factor Z>1), as a consequence of which the physical storage capacity only increases sub-proportionately with the pressure.

The development of metal-hydride storage media, in which the hydrogen is chemically bound, is already very well advanced. However, large amounts of heat are formed during charging of the storage media, which have to be dissipated in a short time during filling of the tank. Correspondingly high temperatures are necessary during discharge in order to expel the hydrogen from the hydrides. Both require the use of considerable amounts of energy for cooling/heating, which impairs the efficiency of the storage media. These disadvantages are caused by the thermodynamics of storage. In addition, the kinetics of hydride-based hydrogen storage media are poor, which increases the time needed for filling the tank and makes the provision of hydrogen during operation more difficult. Materials having faster kinetics are known (for example alanates), but they are pyrophoric, which limits use in motor vehicles.

In summary, essentially three concepts are thus currently under discussion for hydrogen storage besides conventional pressurised storage: cryostorage, chemical storage media and adsorptive storage [see L. Zhou, Renew. Sust. Energ. Rev. 2005, 9, 395-408]. Cryostorage (liquid hydrogen) is tech-nically complex and associated with high evaporation losses, while chemical storage using hydrides requires additional energy for decomposition of the hydride, which is frequently not available in the vehicle. An alternative is adsorptive storage, in which the gas is adsorbed in the pores of a nanoporous material. The density of the gas inside the pores is thus increased. In addition, desorption is associated with a self-cooling effect, which is advantageous for adsorptive cryostorage. However, the heat flows during adsorption and desorption are much smaller than in the case of hydrides and therefore do not represent a fundamental problem.

To date, porous materials, such as zeolites or active carbons, have traditionally been employed for gas storage. Owing to the low density of active carbons, however, only low energy densities are achieved.

Recently, remarkable results have been achieved using inorganic/organic hybrids, so-called metal-organic frameworks (MOFs), which have a storage capacity which is far superior to that of zeolites or active carbons. MOFs are hybrid materials which consist of an inorganic cluster (determines the topology of the network) and an organic linker, which can be employed in a modular manner and allows pore size and functionality to be designed in a variable manner. Initial investigations of hydrogen storage using MOFs (for example MOF-5) originate from Yaghi et al. Science 2003, 300, 1127-1129.

EP-0 727 608 describes the use of organometallic complexes for the storage of gaseous C₁₋to C₄₋hydrocarbons. However, the complexes disclosed therein are difficult to synthesise. Furthermore, the storage capacity of the materials described is low, if not too low, for industrial applications.

J. Am. Chem. Soc. 2004, 126, 5666-5667 describes so-called IRMOFs (isoreticular metal-organic frameworks), which consist, for example, of Zn₄O clusters and a linear dicarboxylate linker, such as naphthalene dicarboxylate (NDC). They enable storage of up to 2% of hydrogen and are produced in the form of a finely particulate powder. During filling of a tank, this powder has to be compacted or pressed, during which a significant part of the storage capacity is lost (up to one third).

In addition, the pressing hinders gas transport the pores are less readily accessible. The filling and emptying of the tank is thus slowed. Furthermore, the material does not have a bimodal pore distribution of transport and storage pores, i.e. the MOFs do not have any transport pores (pore diameter 0.1 to 2 μm). A type of transport pores can only be established through the degree of compaction via the cavities between the particles.

A further disadvantage of MOFs consists in their chemical instability compared with other highly porous materials on a purely organic or purely inorganic basis. Many MOFs are moisture-sensitive; their networks dissolve more or less quickly in the presence of water, so that they lose some of their storage capacity.

The object of the present invention was therefore to develop a monolithic storage material which, with a high specific surface area, eliminates the disadvantages of pulverulent materials and which can be installed in the form of blocks or cylinders in tanks.

The present object is achieved by carbonising a hybrid material consisting of a metal oxide or semimetal oxide framework, preferably silica, and a polymer, preferably a phenolic resin, in a controlled manner. The prerequisite for obtaining a stable monolithic here are two homogeneous, bicontinuous phases of oxide and polymer.

The present invention thus relates to a porous monolith obtainable from an inorganic/organic hybrid material by thermal treatment under non-oxidising conditions. The porous monolith is also preferably referred to as “porous carbon monolith”.

The “thermal treatment under non-oxidising conditions” is also referred to as “carbonisation” in connection with the present invention. The degree of carbonisation of the organic phase can be freely selected and matched to the needs of use. Through a suitable choice of temperature, duration and atmosphere, the person skilled in the art can determine the degree of carbonisation. The carbonisation is preferably carried out with exclusion of air or under an inert-gas atmosphere (nitrogen or argon). The carbonisation is particularly preferably carried out at a temperature T<890° C., more preferably at about 800° C. The duration of the carbonisation is a few hours, preferably 2 to 4 hours, more preferably about 3 hours.

For certain applications according to the invention, it may be advantageous only to dissolve out the inorganic (═oxidic) phase partially.

“Carbon monolith” here denotes a monolith whose proportion by weight of carbon is at least 50%, preferably at least 80%, compared with the proportion by weight of the oxidic or inorganic framework. The inorganic phase is preferably removed by dissolving out.

The term metal or semimetal oxide here encompasses both metal or semi-metal oxides in the actual sense and also oxides which additionally comprise metal or semimetal hydroxides (mixed oxides/hydroxides). The metal or semimetal oxide framework is preferably a framework comprising silicon dioxide/hydroxide, titanium dioxide/hydroxide, zirconium dioxide/hydroxide or hafnium dioxide/hydroxide.

In this connection, “highly porous” means that the micropore volume, determined by the Dubinin method, is at least 10%.

Surprisingly, the cationic polymerisation, preferably “double ring-opening polymerisation”, of certain metal or semimetal spiro compounds, such as, for example, 2,2′-spirobi[4H-1,3,2-benzodioxasilyne] (abbreviated to SPISI), results in stable monoliths having two bicontinuous, homogeneous and nanostructured silica and phenolic resin phases of this type, which can be carbonised to give highly porous materials without loss of the monolithic structure. The transport pores necessary for gas transport in the monolith can be formed comfortably here directly during the polymerisation through the choice of corresponding starting compounds and/or the addition of structure-forming substances, such as, for example, surfactants. In a further step, the metal or semimetal oxide framework can be dissolved out of the monolith, which results in a stable carbon monolith having a very high micropore content which is particularly suitable for the storage of gases. In accordance with the invention, the micropores have pore radii of between 0.5 nm and 2 nm.

The advantageous bicontinuous structure comprising inorganic and organic phases of the hybrid material is already achieved through the use of a single starting material, from which the two phases form simultaneously. The phases separate during the polymerisation without a reaction product being precipitated. Instead, the separation takes place on a length scale in the nanometre range. The two phases which form during the polymerisation diffuse into one another completely and continuously. The formation of isolated domains cannot be observed if the reaction is carried out correctly. Examples of a “double condensation polymerisation” of this type (i.e. formation of two polymers from one monomer) have already been described in Angew. Chem. 119, 636-640 (2007). However, the materials described here are not suitable for the preparation of highly porous, carbon-based storage materials since the polyfurfuryl alcohol formed depolymerises from a temperature of about 400° C. and therefore cannot be carbonised completely.

The formation of a low-molecular-weight cleavage product during the reaction is avoided with novel spiro compounds of the general formula I

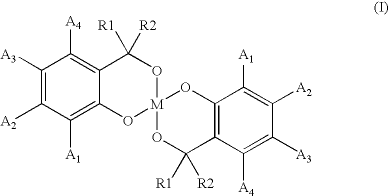

and/or compounds of the general formula II

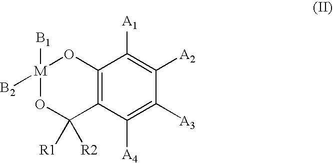

where
M is a metal or semimetal, preferably Si, Ti, Zr or Hf, particularly preferably Si or Ti,
A₁, A₂, A₃, A₄, independently of one another, are hydrogen or linear or branched, aliphatic hydrocarbon radicals, aromatic hydrocarbon radicals or aromatic-aliphatic hydrocarbon radicals,
B₁ and B₂, independently of one another, are linear or branched aliphatic or aromatic hydrocarbon radicals, which may contain heteroatoms, where ring closures via one or more carbon atoms or heteroatoms exist between the groups B₁ and B₂, preferably linear hydrocarbon radicals, particularly preferably methyl or ethyl groups,
R₁, R₂, independently of one another, are hydrogen or an alkyl group having 1 to 6 carbon atoms, preferably methyl or H,
   or combinations of the two formulae. The hybrid materials formed are distinguished by a very homogeneous distribution of the two phases. The transparency of the monoliths formed suggests that no domains of one of the two phases form in the reaction.

Preferably, two or more than two of the radicals A₁ to A₄ are linked to one another, in particular fused, i.e. linked to give a common aromatic ring system.

It is furthermore preferred for one or more carbon atoms of the radicals A₁ to A₄ to have been replaced, independently of one another, by hetero-atoms, in particular by oxygen, sulfur and/or nitrogen. In addition, it is preferred for A₁ to A₄ to contain, independently of one another, one or more functional groups. Possible functional groups are, in particular, the following groups: halogen, in particular bromine, chlorine or also —CN and —NR₂, where R is, in particular, hydrogen or an aliphatic or aromatic hydrocarbon radical, preferably H, methyl, ethyl or phenyl.

It is furthermore preferred in accordance with the invention for the radicals R₁ and R₂ to be, independently of one another, hydrogen or an alkyl group having 1 to 6 carbon atoms. R₁ and R₂ are preferably selected from hydrogen and methyl. R₁ and R₂ are particularly preferably equal to H. In addition, at least one of the two radicals A₁ and A₃ is particularly preferably a hydrogen atom. In a very particularly preferred embodiment, both A₁ and A₃ are a hydrogen atom. In addition, A₁ to A₄ are very particularly preferably equal to H. The compound 2,2′-spirobi[4H-1,3,2-benzodioxasilyne] is the most preferred.

After the carbonization of these monoliths, preferably at temperatures around 800° C. under an inert gas, a porous, still monolithic material consisting of a metal or semimetal oxide framework and carbon is obtained. The porosity is increased enormously by dissolving out the oxide phase (for example by means of aqueous HF solution). The carbon here has a large number of micropores, which are particularly suitable for the storage of gases.

The addition of substances which form a homogeneous mixture with the monomer or monomers according to the invention, but cause phase separation during the polymerisation, enables the production of systems having an additional continuous (third) phase. If the additives are selected in such a way that the additional (third) phase can be removed, for example, by dissolving out, by depolymerisation or during the carbonisation, a continuous transport-pore system which promotes gas transport within the storage material forms.

Additives which can be employed are inert substances, such as polyethylene glycol or polyTHF, reactive, likewise polymerising substances, such as furfuryl alcohol and derivatives thereof, in particular ethers and esters thereof, or additional monomers of the general formula II or III

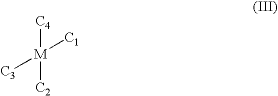

where
M is a metal or semimetal, preferably Si, Ti, Zr or Hf,
C₁ to C₄, independently of one another, are groups formed from linear, branched and/or cyclic aliphatic or aromatic hydrocarbons, which may contain heteroatoms, and of which at least one of the groups C₁ to C₄ is bonded to the central metal or semimetal atom via oxygen.
C₁ to C₄ are preferably furfuryloxy groups or polyethylene glycol radicals.

In addition, the phase separation can be influenced in accordance with the invention by structure-forming surfactants. Ionic and nonionic surfactants can be used here. The choice of suitable compounds is made in accordance with criteria known to the person skilled in the art.

The present invention furthermore relates to an inorganic/organic hybrid material (composite) obtainable by polymerisation, preferably by double ring-opening polymerisation, of one or more monomer units selected from the group of the spiro compounds of the general formula I, as indicated above, where A₁ and A₃ denote H, and/or compounds of the general formula II, as indicated above, where A₁ and A₃ are equal to H.

The invention furthermore relates to a process for the production of porous monoliths comprising the steps of:
a) preparation of a hybrid material by polymerisation of one or more monomer units selected from the group of the spiro compounds of the general formula I

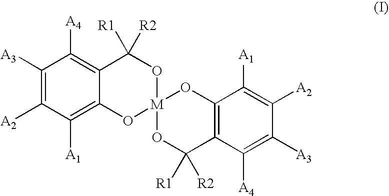

and/or compounds of the general formula II

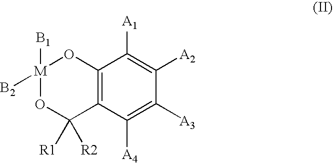

where M, A₁, A₂, A₃, A₄, B₁, B₂, R₁ and R₂ have the meanings indicated above, where A₁ and A₃ are equal to hydrogen,
where structure-forming surfactants may additionally be added,
b) carbonisation of the organic constituents, giving a porous carbon body which is stabilised via an oxide framework.

It is preferred for partial or complete dissolving-out of the inorganic oxide phase to be carried out after the carbonisation in order to obtain a carbon monolith.

In a preferred embodiment, the polymerisation is carried out in the presence of tetrafurfuryl orthosilicate. The polyfurfuryl alcohol formed here forms a continuous phase in the monolith. During the carbonisation, the polyfurfuryl alcohol partially depolymerises to give gaseous products. Macropores, which act as transport pores, can thus be introduced into the later carbon monolith.

In a further preferred embodiment, the polymerisation is carried out in the presence of polyethylene glycol or poly-THF. Due to phase separation during the polymerisation, these substances likewise form a continuous phase via which transport pores can be introduced into the carbonised system.

In a further preferred embodiment, starting substances of the general formula II are used as comonomers. The siloxane compounds formed in the reaction can easily be dissolved out of the monolith before the carbonization and thus result in the desired transport pores.

The spiro compounds of the formula I are prepared by reacting a compound of the formula IV

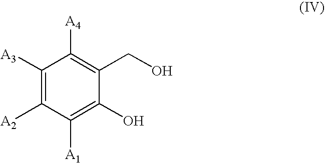

where
A₁ to A₄, independently of one another, are linear or branched, aliphatic or aromatic hydrocarbon radicals, which may contain heteroatoms, where ring closures via one or more carbon atoms or hetero-atoms exist between two or more groups from A₁ to A₄, or two or more groups from A₁ to A₄ may be built up from parts of the same aromatic system comprising one or more rings, into which the existing benzene ring from which A₁ to A₄ originate may be bonded,
   with at least one alkoxy and/or halogen compound of the elements Si, Ti, Zr or Hf, preferably Si or Ti.

The alkyl compound employed is preferably in accordance with the invention tetraalkyl orthosilicates or tetraalkyl titanates. Particular preference is given to tetramethyl and tetraethyl orthosilicate and tetraisopropyl titanate.

The present invention furthermore relates to an apparatus for the accommodation and/or storage and/or release of at least one gas, comprising the carbon monolith according to the invention, and to an apparatus for filtering gases.

The apparatus according to the invention may comprise the following further components:
a container which accommodates the material according to the invention;
an aperture for feed or discharge, which enables at least one gas to enter or leave the apparatus;
a gas-tight accommodation mechanism which is capable of keeping the gas under pressure within the container.

The invention furthermore relates to the use of spiro compounds of the formulae I and/or II for the production of carbon monoliths for gas storage.

The present invention furthermore relates to the use of the porous monoliths produced in accordance with the invention as gas-storage material. In a preferred embodiment, the porous monolithic materials according to the invention are employed for the storage of hydrogen. More preferably, they are employed for the storage of natural gas, preferably methane.

The following examples are intended to illustrate the present invention. However, they should in no way be regarded as limiting. All compounds or components which can be used in the compositions are either known and commercially available or can be synthesised by known methods. The temperatures indicated in the examples are always in ° C. It furthermore goes without saying that, both in the description and in the examples, the added amounts of the components in the compositions always add up to a total of 100%. Percentage data given should always be regarded in the given context. However, they usually always relate to the weight of the part amount or total amount indicated. Toluene and dichloromethane were dried.

### EXAMPLES

### Example 1

### Preparation of 2,2″-spirobi[4H-1,3,2-benzodioxasilyne](SPISI)

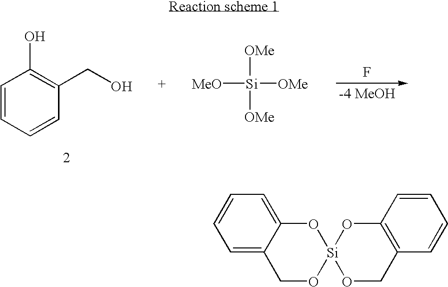

35.00 g of salicyl alcohol (0.28 mol) are dissolved in 300 ml of toluene at 80° C., and 0.1 ml of tetra-n-butylammonium fluoride (1 M in THF) is subsequently added. 21.46 g (0.14 mol) of tetramethoxysilane are slowly added dropwise to the solution. The mixture is stirred at 80° C. for a further hour, and the pressure is subsequently reduced in order to distil off remaining methanol. The resultant solution is decanted from impurities, and the product is isolated by further distillation of the toluene. Reprecipitation from hexane gives a white solid (70% of theory). ¹H-NMR 400 MHz, CDCl₃, 25° C., TMS) δ [ppm]=5,21 (m, 4H, CH₂), 6.97-7.05 (m, 6H), 7.21-7.27 (M, 2H).

### Example 2

### Cationic Polymerisation (Double Polymerisation) of 2,2′-spirobi[4H-1,3,2-benzodioxasilyne] to give the Phenolic Resin/Silica Nanocomposite

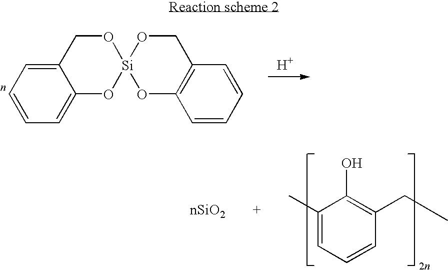

The monomer prepared in accordance with example 1 is melted at 80° C. under argon or dissolved in chloroform at 25° C. The initiator trifluoroacetic acid is added dropwise with stirring, and the reaction mixture is stirred at the same temperature for a further 3 h and subsequently left to stand at 25° C. The formation of the SiO₂ phase and of the phenolic resin is con-firmed unambiguously by solid-state NMR spectroscopy.

### Example 3

### Oxidation to Give Nanoporous Silica

The composite monoliths are heated to 900° C. at 2 K/min with supply of air and calcined at this temperature for 3 h.

### Example 4

### Preparation of Porous Carbon by Carbonisation

The composite monoliths are heated to 800° C. at 2 K/min under argon and calcined at this temperature for 3 h. The resultant carbon/silica composite is left in an aqueous HF solution (40%) for 3 days, then rinsed a number of times with distilled water and finally with methanol and dried at 120° C. in vacuo. This dissolves out the silica phase and gives a nanoporous carbon monolith. The density is about 0.9 g/cm³.

### INDEX OF FIGURES

FIG. 1: shows the Dubinin pore distribution of a nanoporous carbon monolith produced from the phenolic resin/SiO₂ composite according to the invention. The spec. surface area is 840 m²/g (Dubinin) or 810 m²/g (BET). The micropore volume is 0.297 cm³/g; carbon phase (C: 90.9 mol %)

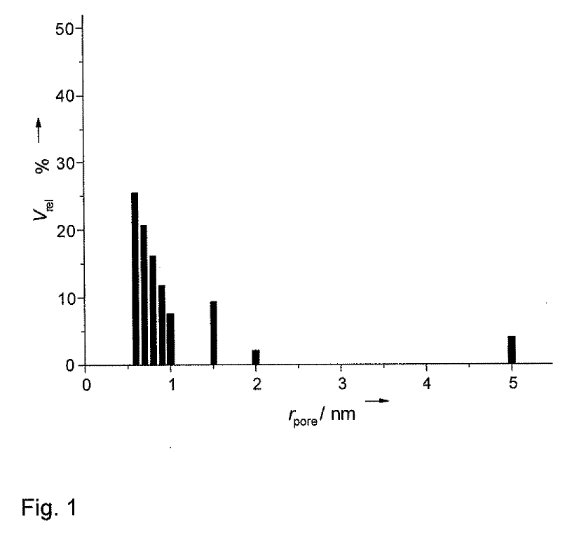

1. Porous monolith obtainable from an inorganic/organic hybrid material by thermal treatment under non-oxidising conditions.

2. Porous monolith obtainable from a hybrid material which forms through polymerisation of one or more monomer units selected from the group of the spiro compounds of the general formula I 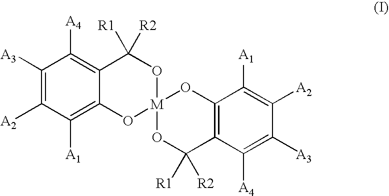
and/or compounds of the general formula II 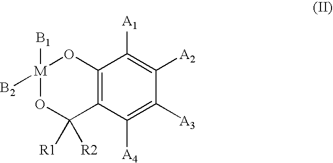
where
M is a metal or semimetal, preferably Si, Ti, Zr or Hf, particularly preferably Si or T₁,
A₁, A₂, A₃, A₄, independently of one another, are linear or branched, aliphatic or aromatic hydrocarbon radicals, which may contain heteroatoms, where ring closures via one or more carbon atoms or heteroatoms exist between two or more groups from A₁ to A₄, or two or more groups from A₁ to A₄ may be built up from parts of the same aromatic system comprising one or more rings, into which the existing benzene ring from which A₁ to A₄ originate may be bonded,
B₁, B₂, independently of one another, are linear or branched aliphatic or aromatic hydrocarbon radicals, which may contain heteroatoms, where ring closures via one or more carbon atoms or heteroatoms exist between the groups B₁ and B₂,
R₁, R₂, independently of one another, are hydrogen or an alkyl group having 1 to 6 C atoms, preferably methyl or H,
where structure-forming surfactants are optionally added, and subsequent complete or partial carbonisation of organic constituents.

3. Porous monolith according to claim 1, characterised in that the proportion by weight of carbon in the monolith is at least 50%, based on the total solids content of the monolith.

4. Porous monolith according to claim 1, obtainable by a process in which all or some of the inorganic phase is removed after the carbonisation of organic constituents.

5. Porous monolith according to claim 1, characterised in that the hybrid material comprises an inorganic, porous metal or semimetal oxide framework and a polymer.

6. Porous monolith according to claim 1, characterised in that the metal or semimetal oxide employed is silicon dioxide/hydroxide, titanium dioxide/hydroxide, zirconium dioxide/hydroxide or hafnium dioxide/hydroxide.

7. Porous monolith according to claim 1, characterised in that the polymer is a phenolic resin.

8. Inorganic/organic hybrid material obtainable by polymerisation of one or more monomer units selected from the group of the spiro compounds of the general formula I according to claim 2, and/or compounds of the general formula II according to claim 2, where M, A₁ to A₄, B₁, B₂, R₁, R₂ have the meanings according to claim 2, where A₁ and A₃ are equal to H.

9. Inorganic/organic hybrid material according to claim 8, characterised in that the polymerisation is a cationic polymerisation, preferably a double ring-opening polymerisation.

10. Process for the production of porous monoliths comprising the steps of:
a) preparation of a hybrid material by polymerisation of one or more monomer units selected from the group of the spiro compounds of the general formula I 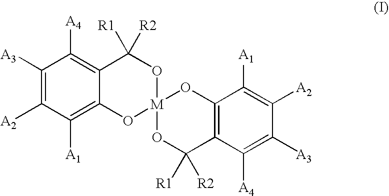
and/or compounds of the general formula II 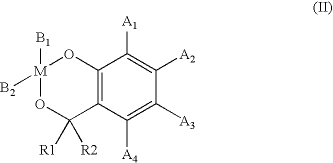
where
M is a metal or semimetal, preferably Si, Ti, Zr or Hf,
A₁ to A₄, independently of one another, are linear or branched, aliphatic or aromatic hydrocarbon radicals, which may contain heteroatoms, where ring closures via one or more carbon atoms or heteroatoms exist between two or more groups from A₁ to A₄, or two or more groups from A₁ to A₄ may be built up from parts of the same aromatic system comprising one or more rings, into which the existing benzene ring from which A₁ to A₄ originate may be bonded,
B₁ and B₂, independently of one another, are linear or branched aliphatic or aromatic hydrocarbon radicals, which may contain heteroatoms, where ring closures via one or more carbon atoms or heteroatoms exist -between the groups B₁ and B₂,
R₁, R₂, independently of one another, are hydrogen or an alkyl group having 1 to 6 C atoms, preferably methyl or H,
where structure-forming surfactants are optionally added,
b) complete or partial carbonisation of organic constituents, giving a porous monolith which is stabilised via an oxide framework.

11. Process according to claim 10, characterised in that complete or partial removal of the inorganic oxide phase is completed after the carbonisation of organic constituents.

12. Apparatus for the accommodation and/or storage and/or release of at least one gas, comprising a porous monolith according to claim 1.

13. Apparatus according to claim 12, characterised in that it additionally comprises a container which accommodates the porous carbon monolith; an aperture or outlet which enables at least one gas to enter or leave the apparatus; a gas-tight accommodation mechanism which is capable of keeping the gas under pressure within the container.

14. A process for storing gas comprising contracting a monolith according to claim 1 with a gas to be stored.
